(19) United States
(12) Patent Application Publication
(10) Pub. No.: US 2010/0174917 A1
(43) Pub. Date: Jul. 8, 2010

(54) INFORMATION RECORDING MEDIUM, REPRODUCING APPARATUS AND CUMPUTER PROGRAM

(75) Inventor: Keiji Katata, Saitama-ken (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/666,157

(22) PCT Filed: Jul. 3, 2007
(86) PCT No.: PCT/JP2007/063277

§ 371 Date: Dec. 22, 2009

(51) Int. Cl. G06F 12/14

(52) U.S. Cl. 713/189

(57) ABSTRACT

An information recording medium (1) includes a recording area (12) in which a content (122) which is encrypted by an encryption key in a first encryption system and first key information (121) for obtaining the encryption key by a second encryption system that is different from the first encryption system are recorded and a control information area (11) in which second key information (112) for obtaining the encryption key by at least first encryption system and a flag (111) for deciding which system is to be used, either the first encryption system or the second encryption system, are recorded. At the time of reproduction, when the encryption key is obtained by the system decided by the flag and the content is reproduced, the content can be properly protected while keeping compatibility with the existing content protection technology.

### TECHNICAL FIELD

The present invention relates to an information recording medium, a reproducing apparatus and a computer program for protecting content recorded on an information recording medium such as a DVD.

### BACKGROUND ART

In this type of information recording medium, it is tried to protect content recorded on an information recording medium. For example, in a patent document 1, a technique for protecting content by a disc key recorded an information recording medium being encrypted by a public key adapting a reproducing apparatus and the disc key being transmitted to the reproducing apparatus if the reproducing apparatus which is to reproduce the information recording medium is included in a list of reproducing apparatuses being capable of reproducing the content recorded on the information recording medium is described.

Patent document 1: Japanese Patent Application Laid-Open No. 2000-138664.

### DISCLOSURE OF INVENTION

### Subject to be Solved by the Invention

However, according to the aforementioned background art, compatibility with existing content protection technique is not disclosed. Then, there is a technical problem that there is a possibility that it is impossible to use existing hardware resources, for example.

In view of the aforementioned problem, for example, it is therefore an object of the present invention to provide an information recording medium, a reproducing apparatus and a computer program which can adequately protect content with keeping compatibility with existing content protection technique.

### Means for Solving the Subject

The above object of the present invention can be achieved by an information recording medium provided with: a recording area in which content which is encrypted by an encryption key in first encryption system, and first key information for obtaining the encryption key by second encryption system which is different from the first encryption system are recorded; and a control information area in which second key information for obtaining the encryption key by the first encryption system, and a flag for deciding which system is to be used either the first encryption system or the second encryption system, are at least recorded.

According to the information recording medium of the present invention, the information recording medium which is an optical disc such as a DVD is provided with the recording area such as a data area and the control information area such as a read-in area.

In the recording area, content is recorded which is encrypted (i.e. scrambled) by the encryption key such as a title key in the first encryption system which is an existing system such as CSS (Content Scramble System) system. Here, the “content” of the present invention, typically, means visual content i.e. content with picture information or image information such as movies, dramas and cartoons. But, the content of the present invention may include auditory content i.e. content with only voice information.

In the recording area, the first key information, which is encrypted, for obtaining the encryption key by the second encryption system which is different from the first encryption system is further recorded. Therefore, there are at least two ways for a reproducing apparatus (typically, a host computer of the reproducing apparatus) obtaining the encryption key for decoding the content recorded on the information recording medium.

Specifically, for example, if the first encryption system is the CSS system, first way is that a title key which is an encryption key for decoding content is obtained by an existing process in accordance with the CSS system. Namely, a drive module and a host computer of a reproducing apparatus perform authentication each other. Then, if the authentication succeeds, the host computer obtains the title key.

More specifically, if the authentication succeeds, the drive module reads the second key information, which is for example an encrypted disc key, and an encrypted title key that are recorded on the information recording medium, and then transmits to the host computer. The host computer decodes the transmitted second key information by using a master key stored in the host computer in advance. Moreover, the host computer obtains the title key by decoding the encrypted title key by using the decoded second key information.

Second way is that the host computer generates and obtains a title key by using the first key information such as a title key block and unique information of the host computer such as a device key that are different from an existing system and that are recorded in the recording area. In this case, the drive module and the host computer do not perform authentication each other.

In the control information area, at least the flag for deciding which system is to be used either the first encryption system or the second encryption system is recorded. Here, for example, the “flag” is given “0” if the first encryption system which is the existing system is used; is given “1” if the second encryption system is used. Incidentally, in the control information area, parental control, region control and the like may be further recorded.

When the content recorded the information recording medium is reproduced in a reproducing apparatus such as a personal computer which has, for example, an internal or external DVD drive, first, the flag recorded in the control information area is read.

Next, the reproducing apparatus obtains the encryption key in accordance with the first encryption system if a value of the read flag is “0”, and then decodes and reproduces the content by using the obtained encryption key. On the other hand, the reproducing apparatus obtains the encryption key in accordance with the second encryption system if the value of the read flag is “1”, and then decodes and reproduces the content by using the obtained encryption key.

Specifically, for example, if the first encryption system is the CSS system and the value of the read flag is “0”, first, the drive module and the host computer (typically, a software for reproducing content stored in the host computer) of the reproducing apparatus perform authentication each other. Then, if the authentication succeeds, the drive module transmits the title key recorded on the information recording medium to the host computer. The host computer decodes and reproduces the content by using the transmitted title key.

On the other hand, if the value of the read flag is “1”, the drive module transmits the first key information which is recorded on the information recording medium and which is different from the existing CSS system to the host computer. The host computer generates the title key by using the transmitted first key information and unique information stored in the host computer (typically, unique information included in software for reproducing). Then, the host computer decodes and reproduces the content by using the generated title key. Incidentally, only legal licensed manufacturers can obtain the unique information stored in the host computer.

Incidentally, if a way similar to, for example, AACS MKB (Advanced Access Content System Media Key Block) or CPPM MBK (Content Protection for Prerecorded Media Media Key Block) is applied to encrypting the first key information, it is possible to achieve security level which is the same security level of the AACS or the CPPM.

Moreover, if the first key information is analyzed, it is possible to deal with changing a structure of the key information or the like, it is extremely useful in practice.

Incidentally, when content recorded an existing information recording medium in which the flag is not recorded is reproduced, the reproducing apparatus may be adapted to identify the value of the flag as “0” if the flag is not detected. Moreover, in an existing reproducing apparatus, when the content recorded on the information recording medium of the present invention is reproduced, since the existing reproducing apparatus is not adapted to read or detect the flag, the content is reproduced in accordance with the first encryption system which is existing system.

As mentioned above, in the information recording medium of the present invention, the content is encrypted by the first encryption system which is the existing system and is recorded. And there are two ways for the reproducing apparatus obtaining the encryption key for decoding the content recorded on the information recording medium. Therefore, in whichever the existing system or a reproducing apparatus which corresponds to the second encryption system which is a new system, it is possible to reproduce the content recorded on the information recording medium.

On the other hand, when the drive module of the reproducing apparatus corresponding to the second encryption system is adapted not to perform a process according to the first encryption system if the value of the flag is “1” (i.e. the drive module is adapted to only perform a process according to a system which is decided by the flag), the content is not reproduced if the content is tried to reproduce by using illegal software for reproduction which can be stored in the host computer and which uses a security hole in the first encryption system, for example.

The aforementioned illegal software for reproduction is, generally, used on a reproducing apparatus which has an optical drive module, such as a personal computer. Therefore, it is preferable to make such a change that the flag which is recorded on the information recording medium is read to an existing drive module for a personal computer. Incidentally, the change of the drive module, typically, can be realized by updating only firmware without change of hardware.

In this case, a computer program, such as a self-diagnostic program, which judges whether or not the drive module for a personal computer is adopted to read the flag is recorded on the information recording medium. And then, the recorded computer program is adopted to be read first when the information recording medium is set at the drive module.

Then, if it is judged that the drive module is not adopted to read the flag, a message that, for example, encourages a user to update firmware of the drive module is displayed (if necessary, the drive module is become unable to reproduce the content until the firmware is updated), thereby it is possible to avoid reproducing the content by using old firmware and illegal software for reproduction.

Alternatively, software corresponding to the second encryption system which is stored in the host computer is adopted to control the drive module to search such as key information which is different from the first encryption system on the information recording apparatus before performing a process according to the first encryption system, and to perform a process according to the second encryption system which is the new system if the different key information or the like is found. By virtue of such construction, the content is reproduced according to the second encryption system if the drive module does not correspond to the second encryption system. Incidentally, in this case, a message that encourages a user to update firmware of the drive module or the like may be displayed.

Incidentally, a reproducing apparatus such as a DVD player of consumer electronics which is difficult to be updated software for reproduction or the like is typically made no change. In other words, it is not necessary to make a change to a reproducing apparatus which has exceedingly-small possibility that illegal software for reproduction or the like is stored.

As a result, according to the information recording medium of the present invention, it is possible to adequately protect content with keeping compatibility with the existing content protection technique.

Additionally, since change of the drive module typically does not have change of hardware, it little affects or does not affect manufactures' cost of the drive module, it is extremely useful in practice.

In one aspect of the information recording medium of the present invention, the first encryption system is an existing system.

According to this aspect, it is possible to keep compatibility with the existing content protection technique, it is extremely useful in practice.

In this aspect, the existing system may be CSS system.

By virtue of such construction, in a reproducing apparatus corresponding to the CSS system which is widely prevalent, it is possible to reproduce the content recorded on the information recording medium. Moreover, it is possible to reproduce the content recorded on an existing information recording medium in a reproducing apparatus corresponding to the second encryption system which is new system.

The above object of the present invention can be achieved by a reproducing apparatus for reproducing a information recording medium provided with: a recording area in which content which is encrypted by an encryption key in first encryption system, and first key information for obtaining the encryption key by second encryption system which is different from the first encryption system are recorded; and a control information area in which second key information for obtaining the encryption key by the first encryption system, and a flag for deciding which system is to be used either the first encryption system or the second encryption system, are at least recorded, said reproducing apparatus provided with: a reading device for reading the flag; and a reproducing device for obtaining the encryption key by using the second key information or the first key information in accordance with a system which is decided by the read flag, and for reproducing the content by decoding the content by the obtained encryption key.

According to the reproducing apparatus of the present invention, the reproducing apparatus such as a personal computer which has, for example, an internal or external DVD drive reproduces the information recording medium which is provided with a recording area in which content which is encrypted by an encryption key in first encryption system, and first key information for obtaining the encryption key by second encryption system which is different from the first encryption system are recorded, and a control information area in which second key information for obtaining the encryption key by the first encryption system, and a flag for deciding which system is to be used either the first encryption system or the second encryption system are at least recorded.

The reading device in a drive module which is, for example, a DVD drive reads the flag recorded on the information recording medium. The reproducing device in the drive module obtains the encryption key by using the second key information or the first key information in accordance with a system decided by the read flag, and decoded and reproduces the content by the obtained encryption key.

Namely, if it is decided that it is the first encryption system which is an existing system, the reproducing device obtains the encryption key by using the second key information in accordance with the first encryption system, and decodes and reproduces the content. On the other hand, if it is decided that it is the second encryption system which is a new system, the reproducing device obtains the encryption key by using the first key information in accordance with the second encryption system, and decodes and reproduces the content.

In the reproducing apparatus of the present invention, the reproducing device in the drive module obtains key information in accordance with a system which is decided by the read flag, and decodes and reproduces the content. Thus, if illegal software for reproduction is stored in the host computer of the reproducing apparatus, it is possible to avoid reproducing the content by the stored software.

As a result, according to the reproducing apparatus of the present invention, it is possible to adequately protect content with keeping compatibility with the existing content protection technique.

The above object of the present invention can be achieved by a computer program making a computer function as the aforementioned reproducing apparatus of the present invention.

According to the computer program of the present invention, it is possible to relatively easily realize the aforementioned reproducing apparatus of the present invention, by loading the computer program from a recording medium for storing the computer program, such as a CD-ROM (Compact Disc Read Only Memory), a DVD-ROM (Digital Versatile Disc Read Only Memory) or the like, into the computer of the reproducing apparatus, or by downloading the computer program through a communication device. Thus, it is possible to adequately protect content with keeping compatibility with the existing content protection technique in a similar way to the aforementioned reproducing apparatus of the present invention.

The operation and other advantages of the present invention will become more apparent from Best Mode for Carrying Out the Invention described below.

As discussed above in detail, according to the information recording medium of the present invention, it is provided with the recording area and the control information area; according to the reproducing apparatus of the present invention, it is provided with the reading device and the reproducing device; and according to the computer program of the present invention, it makes a computer function as the aforementioned reproducing apparatus, thereby it is possible to adequately protect content with keeping compatibility with the existing content protection technique.

### BRIEF DESCRIPTION OF DRAWINGS

FIG. 1 shows a basic structure of an optical disc of an embodiment of the present invention. An upper part is an epitome plane view of the optical disc which has a plurality of areas. A lower part is a graphical conceptual view of an area structure in its radial direction.

FIG. 2 is a block diagram showing the structure of a reproducing apparatus of the embodiment of the present invention.

FIG. 3 is an explanation drawing showing one example of information stored in a memory of a drive module of the reproducing apparatus of the embodiment of the present invention.

FIG. 4 is an explanation drawing showing one example of information stored in a memory of a host computer of the reproducing apparatus of the embodiment of the present invention.

FIG. 5 is a flowchart showing a reproducing process in the reproducing apparatus of the embodiment of the present invention.

### DESCRIPTION OF REFERENCE CODES

1 optical disc
2 reproducing apparatus
11 read-in area
12 data area
13 read-out area
14 center hole
21 drive module
22 host computer
111 flag
112 DK
121 TKB
122 content data
123 TK

### BEST MODE FOR CARRYING OUT THE INVENTION

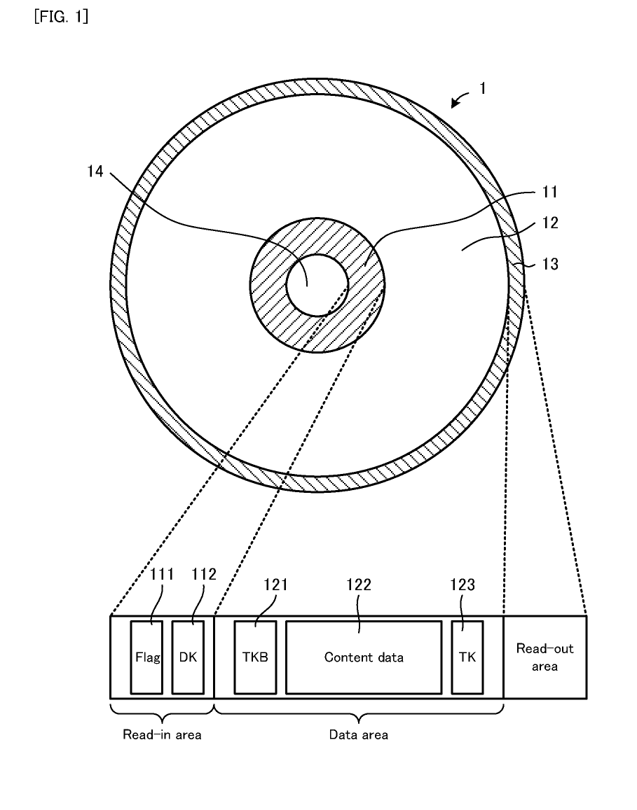

Hereinafter, an embodiment of the reproducing apparatus of the present invention will be described with reference to FIG. 1 to FIG. 5.

<Optical Disc>

First, with reference to FIG. 1, the explanation will be given on an optical disc which is reproduced by a reproducing apparatus of this embodiment as one example of the information recording medium of the present invention. FIG. 1 shows a basic structure of an optical disc of this embodiment. An upper part is an epitome plane view of the optical disc which has a plurality of areas. A lower part is a graphical conceptual view of an area structure in its radial direction.

As shown in FIG. 1, the optical disc 1 which is for example a DVD-ROM has a read-in area 11, a data area 12 and a read-out area 13 on a recording surface of the body of the optical disc 1 in a direction from inter circumference to outer circumference with a central focus on a center hole 14. Here, the “read-in area 11” and the “data area 12” of this embodiment are one example of the “control information area” and the “recording area” of the present invention, respectively.

In the data area 12, TKB (Title Key Block) 121 which is one example of the “first key information” of the present invention, content data 122 and TK (Title Key) 123 are recorded. The TKB 121 is encrypted by a method in a similar way to the AACS MKB, for example. The content data 122 and the TK 123 are encrypted by the CSS system which is one example of the “first encryption system” of the present invention.

In the read-in area 11, a flag 111 which decides which system is to be used for decoding and reproducing the content data 122 either the CSS system or a new system which is one example of the “second encryption system” of the present invention, and a DK (Disc Key) 112 which is encrypted by the CSS system and which is one example of the “second key information” of this embodiment are recorded. Here, the flag 111 is given “0” if the CSS system is used, and is given “1” if the new system is used.

<Reproducing Apparatus>

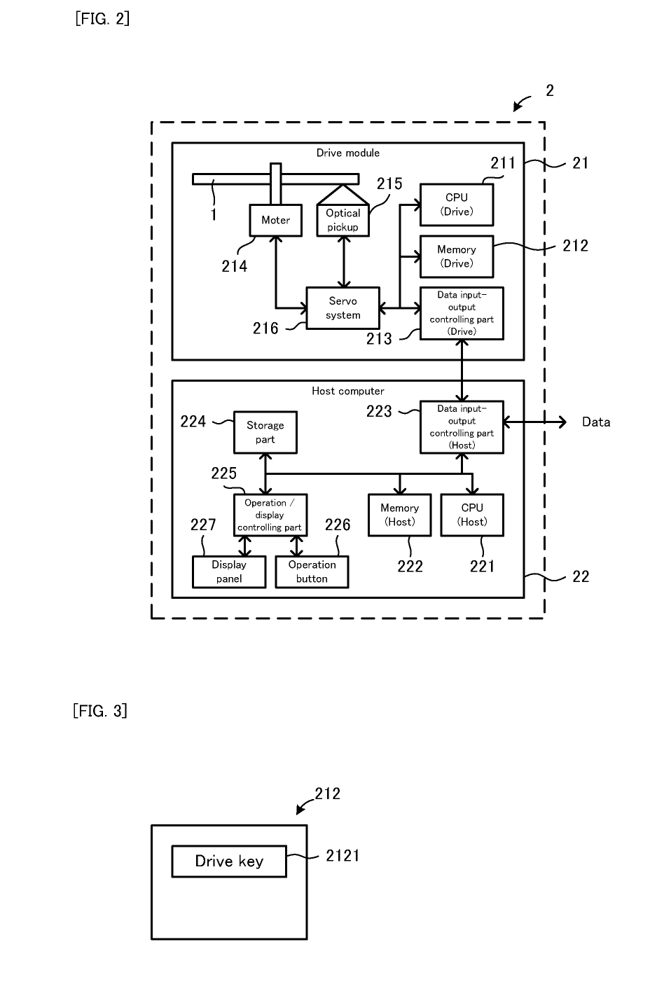

Next, with reference to FIG. 2, the explanation will be given on the structure of the reproducing apparatus of this embodiment. FIG. 2 is a block diagram showing the structure of the reproducing apparatus of this embodiment.

In FIG. 2, the reproducing apparatus 2 which is for example a personal computer having a DVD drive is constructed by it being provided with a drive module 21 and a host computer 22.

The drive module 21 is constructed by it being provided with a CPU (Central Processing Unit) 211, a memory 212, a data input-output controlling part 213, a spindle motor 214, an optical pickup 215 and a servo system 216. Here, the “CPU 211” and the “optical pickup 215” of this embodiment are one example of the “reproducing device” and the “reading device” of the present invention, respectively.

Here, with reference to FIG. 3, the additional explanation will be given on the memory 212. FIG. 3 is an explanation drawing showing one example of information stored in the memory 212 of the drive module 21 of the reproducing apparatus 2 of this embodiment.

As shown in FIG. 3, in the memory 212, at least a drive key 2121 which is unique information of the drive module 21 is stored.

Return to FIG. 2 again, the host computer 22 is constructed by it being provided with a CPU 221, a memory 222, a data input-output controlling part 223, a storage part 224, an operation/display controlling part 225, an operation button 226 and a display panel 227.

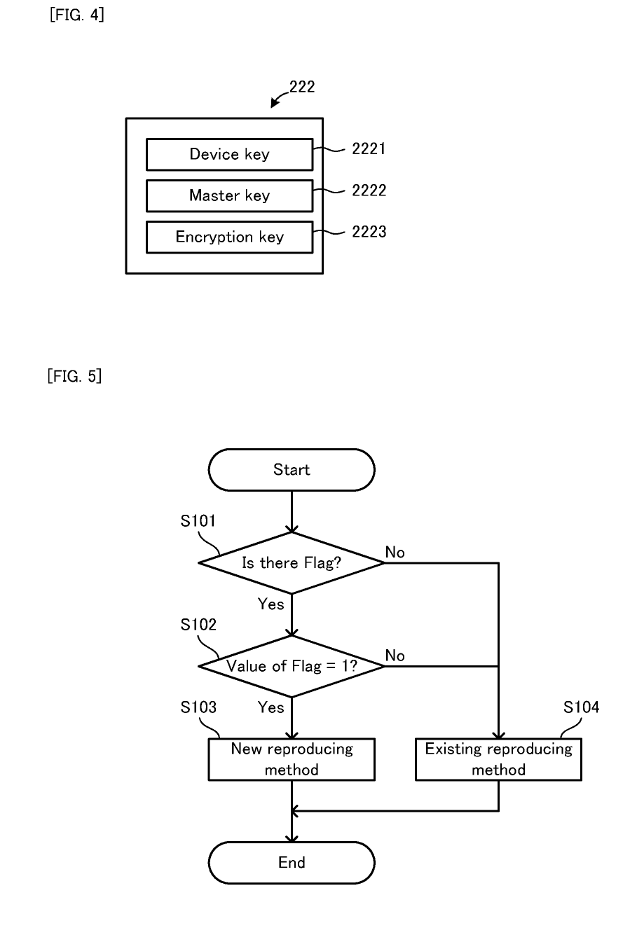

Here, with reference to FIG. 4, the additional explanation will be given on the memory 222. FIG. 4 is an explanation drawing showing one example of information stored in the memory 222 of the host computer of the reproducing apparatus 2 of this embodiment.

As shown in FIG. 4, in the memory 222, at least a device key 2221, a master key 2222 and an encryption key 2223 are stored.

When a button showing reproduction which is included in the operation button 226 of the host computer 22 is pressed by a user, or when signal showing reproduction which is transmitted by such as a remote controller is received, the CPU 221 transmits signal showing detecting the optical disc 1 to the drive module 21 through the data input-output controlling part 223.

The CPU 211 of the drive module 21 controls the optical pickup 215 and so on to detect the optical disc 1 in accordance with the transmitted signal.

If the optical disc 1 is not detected, the CPU 211 transmits signal showing that the optical disc 1 is not detected to the host computer 22. The CPU 221 of the host computer 21 which receives the transmitted signal, typically, controls the operation/display controlling part 225 to display a message showing that the optical disc 1 is not detected or the like on the display panel 227, and terminates the process.

If the optical disc 1 is detected, the CPU 211 of the drive module 21 controls the optical pickup 215 and so on to detect the flag 111 recorded on the optical disc 1. If the flag 111 is detected, then, the flag 111 is read by the optical pickup 215. The CPU 211 reproduces the content data 122 by the new system if the value of the read flag 111 is “1”.

Specifically, first, the CPU 211 controls the optical pickup 215 and so on to read the TKB 121 recorded on the optical disc 1, and then transmits the read TKB 121 to the host computer 22 through the data input-output controlling part 213.

Next, the CPU 211 controls the optical pickup 215 and so on to read the content data 122 recorded on the optical disc 1, and then transmits the read content data 122 to the host computer 22 through the data input-output controlling part 213.

The CPU 221 of the host computer 22 obtains a title key, which is one example of the “encryption key” of the present invention, for decoding the content data 122 from the transmitted TKB 121 by using the device key 2221 stored in the memory 222. Then, the CPU 221 decodes and reproduces the transmitted content data 122 by using the obtained title key.

On the other hand, if the flag 111 is not detected, or if the value of the read flag 111 is “0”, the CPU 211 of the drive module 21 reproduces the content data 122 by a reproducing method according to the existing CSS system.

Specifically, first, the CPU 211 transmits the drive key 2121 stored in the memory 212 to the host computer 22 through the data input-output controlling part 213. The CPU 221 of the host computer 22 transmits the encryption key 2223 stored in the memory 222 to the drive module 21 through the data input-output controlling part 223.

Consequently, authentication is performed between the drive module 21 and the host computer 22, each other. If the authentication succeeds, the CPU 211 of the drive module 21 controls the optical pickup 215 and so on to read the DK 112 and the TK 123 that are recorded on the optical disc 1, and then transmits the read DK 112 and the read TK 123 to the host computer 22 through the data input-output controlling part 213.

Next, the CPU 211 controls the optical pickup 215 and so on to read the content data 122 recorded on the optical disc 1, and then transmits the read content data 122 to the host computer 22 through the data input-output controlling part 213.

The CPU 221 of the host computer 22 decodes the transmitted DK 112 by using the master key 2222 stored in the memory 222. Then, the CPU 221 decodes the transmitted TK 123 by using the decoded DK 112. Then, the CPU 221 decodes and reproduces the transmitted content data 122 by using the decoded TK 123, which is another example of the “encryption key” of the present invention.

According to the study of the present inventor, generally, in regard to a content data protection by the CSS system, since a computer program which can generate a master key is published by analyzing its encryption algorithm, encryption of content data is decoded, thereby the content data is copied or uploaded to a web site, illegally.

On the other hand, it is proposed that content data is protected by a new system such as the AACS system instead of protecting content data by the CSS system. However, manufactures' cost is increased by changing a design of a drive module or it takes time to provide a drive module. Moreover, it is found that it takes time and cost to receive a license of an export regulation or the like.

However, in this embodiment, the TKB 121 for obtaining the title key decoding the content data 122 by a process which is different from the CSS system, and the flag 111 for deciding which system is to be used for decoding and reproducing the content data 122 either the CSS system or the new system are recorded on the optical disc 1 in which the content data 122 encrypted by the CSS system.

And, if the drive module 21 is adopted to perform only a process according to a system which is decided by the flag 111, it is possible to close the security hole of the CSS system and to reproduce the encrypted content data 122 in accordance with the CSS system.

Additionally, since the change of an existing drive module, typically, can be realized by updating only a firmware i.e. hardware is not changed, manufactures' cost and a condition of a license are not changed.

When it is tried to reproduce the content data 122 by using software for reproduction which use the security hole of the CSS system, since the CPU 211 of the drive module 21 does not perform a process according to the CSS system (typically, the authentication between the drive module 21 and the host computer 22 is not performed) if the value of the flag is “1”, the content data 122 is not reproduced.

Moreover, a license of an illegal host computer (typically, software for reproduction stored in the host computer) can be deprived by changing the TKB 121, for example.

Next, the explanation will be given on a reproducing process which is performed by the CPU 211 of the drive module 21 of the reproducing apparatus 2 constructed as above by using a flowchart of FIG. 5.

In FIG. 5, first, the CPU 211 controls the optical pickup 215 and so on to detect the flag 111 in order to judge whether or not the flag 111 is recorded on the optical disc 1 (step S101). If it is judged that the flag 111 is not recorded i.e. the flag 111 is not detected (the step S101: No), the CPU 211 reproduces the content data 122 by performing an existing reproducing method i.e. a process according to the CSS system (step S104).

If it is judged that the flag 111 is recorded i.e. the flag 111 is detected (the step S101: Yes), then, the CPU 211 controls the optical pickup and so on to read the flag 111, and then judges whether or not the value of the read flag 111 is “1” (step S102).

If it is judged that the value of the flag 111 is “1” (the step S102: Yes), the CPU 211 reproduces the content data 122 by performing a new reproducing method i.e. a process according to the new system (step S103). On the other hand, if it is judged that the value of the flag 111 is “0” (the step S102: No), the CPU 211 reproduces the content data 122 in accordance with the existing reproducing method (the step S104).

In the aforementioned embodiment, the optical disc is a DVD-ROM. However, this embodiment can be applied to so-called hybrid-type optical disc which has a once writable area or a rewritable area in addition to a ROM area.

Incidentally, the present invention is not limited to the aforementioned embodiment, but various changes may be made, if desired, without departing from the essence or spirit of the invention which can be read from the claims and the entire specification. An information recording medium, a reproducing apparatus and a computer program, all of which involve such changes, are also intended to be within the technical scope of the present invention.

1. An information recording medium in which content encrypted by an encryption key in first encryption system which is CSS system, said information recording medium comprising:
a recording area in which the encrypted content and first key information for obtaining the encryption key by second encryption system which is different from the first encryption system are recorded; and
a control information area in which second key information for obtaining the encryption key by the first encryption system, and a flag for deciding which system is to be used either the first encryption system or the second encryption system for a reproducing apparatus which reproduces said information recording medium obtaining the encryption key and reproducing the encrypted content are at least recorded.

2. (canceled)

3. (canceled)

4. A reproducing apparatus for reproducing a information recording medium in which content encrypted by an encryption key in first encryption system which is CSS system, said information recording medium comprising: a recording area in which the encrypted content and first key information for obtaining the encryption key by second encryption system which is different from the first encryption system are recorded; and a control information area in which second key information for obtaining the encryption key by the first encryption system, and a flag for deciding which system is to be used either the first encryption system or the second encryption system for a reproducing apparatus which reproduces said information recording medium obtaining the encryption key and reproducing the encrypted content are at least recorded, said reproducing apparatus comprising:
a reading device for reading the flag; and
a reproducing device for obtaining the encryption key by using the second key information or the first key information in accordance with a system which is decided by the read flag, and for reproducing the content by decoding the content by the obtained encryption key.

5. A computer-readable medium containing a computer program for making a computer function as
a reading device for reading a flag from an information recording apparatus in which content encrypted by an encryption key in first encryption system which is CSS system, said information recording medium comprising: a recording area in which the encrypted content and first key information for obtaining the encryption key by second encryption system which is different from the first encryption system are recorded; and a control information area in which second key information for obtaining the encryption key by the first encryption system, and the flag for deciding which system is to be used either the first encryption system or the second encryption system for a reproducing apparatus which reproduces said information recording medium obtaining the encryption key and reproducing the encrypted content are at least recorded; and
a reproducing device for obtaining the encryption key by using the second key information or the first key information in accordance with a system which is decided by the read flag, and for reproducing the content by decoding the content by the obtained encryption key.
